(19) United States
(12) Patent Application Publication
(10) Pub. No.: US 2022/0013077 A1
(43) Pub. Date: Jan. 13, 2022

(54) DISPLAY PANEL DRIVE METHOD AND DRIVE DEVICE

(71) Applicants: HKC CORPORATION LIMITED, SHENZHEN (CN); CHONGQING HKC OPTOELECTRONICS TECHNOLOGY CO., LTD., CHONGQING (CN)

(72) Inventor: Wenqin ZHAO, CHONGQING (CN)

(21) Appl. No.: 16/320,480

(22) PCT Filed: Jul. 16, 2018
(86) PCT No.: PCT/CN2018/095814

§ 371 Date: Jan. 25, 2019

(30) Foreign Application Priority Data
Aug. 30, 2017 (CN) 201710766904.9

(51) Int. Cl. G09G 3/36

(52) U.S. Cl. CPC G09G 3/3685; G09G 2310/0281; G09G 3/3674

(57) ABSTRACT

The present disclosure discloses a display panel drive method and drive device. A display panel includes source driver units distributed on two opposite sides of the display panel and the source driver units are longitudinally or transversely alternately connected to data lines of the display panel. During display drive, a processor controls an input signal of a system end to be output as a data signal and a control signal, then controls, according to the data signal, the source driver units to charge the respectively connected data lines of the display panel, and finally controls a gate drive signal to be input according to the control signal to display the input signal.

### FIELD

The present disclosure relates to the field of liquid crystal display technologies, and particularly, to a display panel drive method and drive device.

### BACKGROUND

With development of liquid crystal display technologies, liquid crystal display systems have been developed towards directions of large size and high definition. At present, each manufacturer actively develops high-resolution 8K television panels. To lighten a load of a source driver (S/D) of a present 8K television panel under an existing drive architecture, a data line of the panel is cut from the middle, an upper S/D provides a charging voltage for an upper half part, and a lower S/D provides a charging voltage for a lower half part. However, inconsistent attenuation of gamma voltages and voltages on source lines may generate a horizontal line at the position of a cutting line, i.e. a middle position of the panel in the horizontal direction, which is referred to as non-uniform cutting in the industry.

### SUMMARY

A main objective of the present disclosure is to provide a display panel drive method and drive device, so as to improve a display effect of the panel.

To achieve the foregoing objective, the present disclosure discloses a display panel drive method, a display panel including S/D units distributed on two opposite sides of the display panel and the display drive method including the following steps:

relatively alternately connecting one or more groups of data lines of the display panel to the S/D units;

controlling an input signal of a system end to be output as a data signal and a control signal;

controlling the S/D units to charge the respectively connected data lines of the display panel; and

controlling a gate drive signal to be input to display the input signal.

Optionally, the display panel includes multiple groups of data lines, the S/D units include a first S/D unit and a second S/D unit, the first S/D unit is connected to odd groups or even groups of the multiple groups of data lines, the second S/D unit is connected to the even groups or odd groups of the multiple groups of data lines, and each of the odd groups and the even groups includes at least one data line.

Optionally, each of the odd groups and the even groups includes a same number of data lines.

Optionally, the S/D units include a first S/D unit and a second S/D unit and are respectively arranged on the two sides, having a longer length, of the display panel.

Optionally, the data lines connected to the first S/D unit are defined as first data lines, the data lines connected to the second S/D unit are defined as second data lines, and the first data lines and the second data lines are alternately arranged.

Optionally, the first data lines and the second data lines are alternately arranged at an interval of multiple groups.

Optionally, the step of controlling the S/D units to charge the respectively connected data lines of the display panel specifically includes the following step:

controlling, according to the data signal, the first S/D unit to charge the data lines in the odd groups or the even groups and simultaneously controlling the second S/D unit to charge the data lines in the even groups or the odd groups.

Another objective of the present disclosure is to disclose a display panel drive device, the drive device including:

multiple groups of S/D units, distributed on two opposite sides of a display panel, one or more groups of data lines of the display panel being relatively alternately connected to the multiple groups of S/D units;

a signal output unit, controlling an input signal of a system end to be output as a data signal and a control signal;

a charging unit, electrically connected to the multiple groups of S/D units to control the multiple groups of S/D units according to the data signal to charge the relatively alternately connected data lines of the display panel; and

a display unit, displaying the input signal when a gate drive signal is input.

Optionally, the display panel includes multiple groups of data lines, the S/D units include a first S/D unit and a second S/D unit, the first S/D unit is connected to odd groups or even groups of the multiple groups of data lines, the second S/D unit is connected to the even groups or odd groups of the multiple groups of data lines, each of the odd groups and the even groups includes at least one data line, and the charging unit is further configured to:

control, according to the data signal, the first S/D unit to charge the data lines in the odd groups or the even groups and simultaneously control the second S/D unit to charge the data lines in the even groups or the odd groups.

Optionally, each of the odd groups and the even groups includes a same number of data lines.

Optionally, the S/D units include a first S/D unit and a second S/D unit and are respectively arranged on the two sides, having a longer length, of the display panel.

Optionally, the data lines connected to the first S/D unit are defined as first data lines, the data lines connected to the second S/D unit are defined as second data lines and the first data lines and the second data lines are alternately arranged.

Optionally, the first data lines and the second data lines are alternately arranged at an interval of multiple groups.

The present disclosure further discloses a display panel drive method, a display panel including a first S/D unit and a second S/D unit distributed on two opposite sides of the display panel and the display drive method including the following steps:

longitudinally or transversely alternately connecting one or more groups of data lines of the display panel to odd groups and even groups of multiple groups of data lines of the S/D units;

controlling an input signal of a system end to be output as a data signal and a control signal;

controlling, according to the data signal, the first S/D unit to charge the data lines in the odd groups or the even groups and simultaneously controlling the second S/D unit to charge the data lines in the even groups or the odd groups; and

controlling a gate drive signal to be input according to the control signal to display the input signal.

Optionally, each of the odd groups and the even groups includes at least one data line.

Optionally, each of the odd groups and the even groups includes a same number of data lines.

Optionally, the S/D units include a first S/D unit and a second S/D unit and are respectively arranged on the two sides, having a longer length, of the display panel.

Optionally, each of the odd groups and the even groups includes two data lines, the first S/D unit is positioned at an upper half part or a lower half part of the display panel when being longitudinally alternately connected to the data lines and is positioned at a left half part or a right half part of the display panel when being transversely alternately connected to the data lines, the second S/D unit is positioned at the lower half part or the upper half part of the display panel when being longitudinally alternately connected to the data lines and is positioned at the left half part or the right half part of the display panel when being transversely alternately connected to the data lines, and the longitudinally alternate or transversely alternate first S/D unit and a second S/D unit perform charging at any position of the display panel.

Optionally, the display panel further includes a gate driver (G/D) unit, the display panel further includes a G/D unit distributed on a side, having a shorter length, of the display panel, and the G/D unit sequentially outputs a voltage to scan lines, connected thereto, of the display panel.

According to the display panel drive method and drive device of the present disclosure, the display panel includes the S/D units distributed on the two opposite sides of the display panel and the S/D units are longitudinally or transversely alternately connected to the data lines of the display panel. During display drive, a processor controls the input signal of the system end to be output as the data signal and the control signal, then controls, according to the data signal, the S/D units to charge the respectively connected data lines of the display panel, and finally controls the gate drive signal to be input according to the control signal, and the input signal is displayed. In such a manner, the S/D units on the two sides of the display panel provide charging voltages for the respectively connected data lines of the display panel when the display panel is driven for display. Therefore, non-uniform cutting caused by inconsistent attenuation of gamma voltages and voltages on the data lines is avoided and a display effect of the panel is improved.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may derive other drawings from these accompanying drawings without creative efforts.

FIG. 1 is a structural diagram of an embodiment of a display panel according to the present disclosure;

FIG. 2 is a structural diagram of another embodiment of a display panel according to the present disclosure; and

FIG. 3 is a flowchart of an embodiment of a display drive method according to the present disclosure.

The objective implementation, functional features, and advantages of the present disclosure will be further illustrated with reference to the accompanying drawings by using embodiments.

### DETAILED DESCRIPTION OF THE INVENTION

It is to be understood that specific embodiments described herein are only adopted to explain the present disclosure and not intended to limit the present disclosure.

The present disclosure discloses a display panel drive method, which is applied to a display device such as a television or a computer.

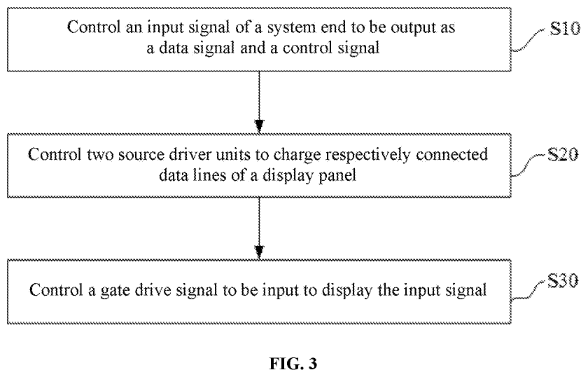

Referring to FIG. 3, FIG. 3 is a flowchart of an embodiment of a display panel drive method according to the present disclosure.

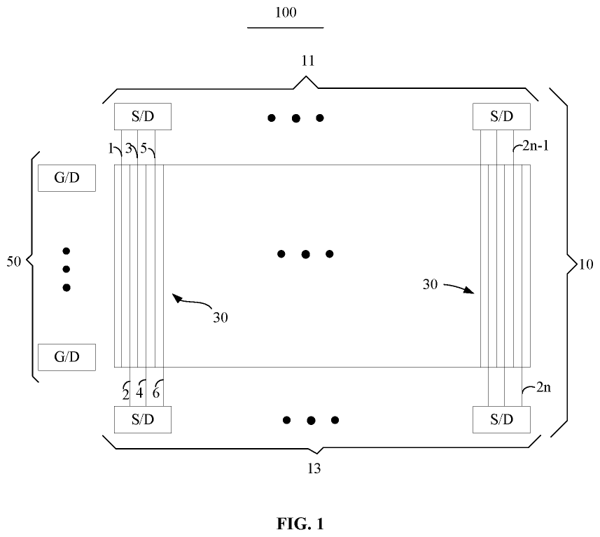

Referring to FIG. 1, FIG. 1 is a structural diagram of an embodiment of a display panel according to the present disclosure.

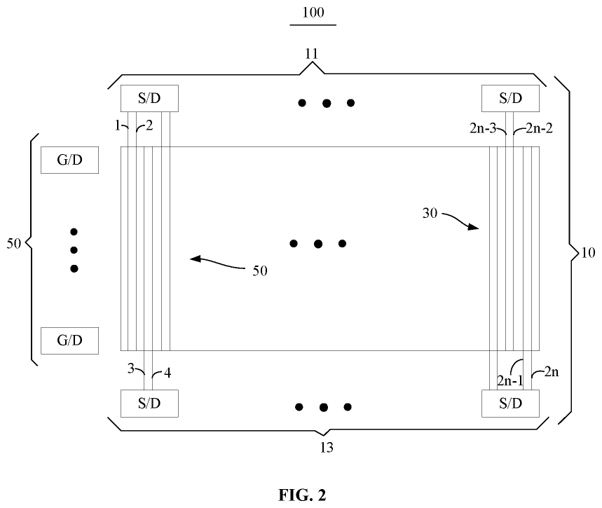

Referring to FIG. 2, FIG. 2 is a structural diagram of another embodiment of a display panel according to the present disclosure.

In the above two embodiments, the display panel 100 includes S/D units 10 distributed on two opposite sides of the display panel 100. The S/D units 10 are longitudinally or transversely alternately connected to data lines 30 of the display panel 100. The drive method includes the following steps.

S10: Control an input signal of a system end to be output as a data signal and a control signal.

S20: Control the S/D units to charge the respectively connected data lines of the display panel.

S30: Control a gate drive signal to be input to display the input signal.

Under a normal circumstance, a display panel includes a timer control register (TCON), an S/D, a G/D, a data line (or a signal line) and a scan line. The TCON is configured to process an input image signal into a data signal and a control signal for transmission to the S/D and the G/D respectively. The S/D is responsible for providing data required to be displayed by the display panel, connected to a source of a thin film transistor and responsible for charging a liquid crystal capacitor. The G/D is responsible for level control of a gate of the thin film transistor of the display panel. When an image is displayed, the S/D provides a charging voltage for the data line of the display panel and the G/D outputs a voltage through the scan line to control the thin film transistor of the display panel to be switched on and off for display of the image signal.

According to the display panel of the present disclosure, to lighten a load of the S/D, an S/D unit 10 is arranged on each of the two opposite sides of the display panel 100. The S/D units 10 are longitudinally or transversely alternately connected to the data lines 30 of the display panel 100 and charge the respectively connected data lines 30 of the display panel 100. The phenomenon of non-uniform cutting formed at a middle position of the display panel due to the fact that the S/D units are adopted for charging from the two sides to the middle in an existing display panel is avoided.

The display panel 100 of the present disclosure includes the S/D units 10 distributed on the two opposite sides of the display panel 100, and the S/D units 10 are alternately connected to the data lines 30 of the display panel 100 and charge the data lines 30 of the display panel 100. In such a manner, the S/D units 10 on the two sides of the display panel 100 provide charging voltages for the respectively connected data lines 30 of the display panel 100 when the display panel 100 is driven for display. Therefore, non-uniform cutting caused by inconsistent attenuation of gamma voltages and voltages on the data lines is avoided and a display effect of the display panel is improved.

Furthermore, referring to FIGS. 1 and 2, the display panel 100 includes the S/D units 10 arranged on the two opposite sides, for example, the two sides having a longer length, of the display panel 100. The S/D units 10 are alternately connected to the data lines 30 of the display panel 100. Specifically, a first S/D unit 11 positioned on one side of the display panel 100 is connected to odd groups of data lines 30 of the display panel 100 and a second S/D unit 13 positioned on the other side of the display panel 100 is connected to even groups of data lines 30 of the display panel 100. The S/D units 10 cooperate to charge liquid crystals in the display panel 100. After the input signal is input to a control board or a TCON, the control board or the TCON decomposes the input signal into a data signal with image data and a sequential control signal, then the S/D units 10 on the two opposite sides of the display panel 100 are controlled according to the data signal to charge the respectively connected data lines 30, and the gate drive signal is finally controlled to be input according to the control signal to display the input signal.

According to the display drive method of the present disclosure, the two S/D units 10 are controlled according to an architecture composition of the display panel 100 and according to the output data signal to simultaneously input the charging voltages to the respectively connected data lines 30 of the display panel 100 to charge the liquid crystals in the display panel 100, and then the gate drive signal is controlled to be input according to the output control signal to display the input signal. The condition that a cutting line is formed due to non-uniform display at the middle position of the display panel under influence of non-uniform impedance of the display panel when the S/D units charge the middle position of the display panel through the data lines is avoided, and the display effect of the display panel 100 is improved.

Optionally, referring to FIG. 1 and FIG. 2, the display panel 100 includes multiple groups of data lines 30, the S/D units 10 include the first S/D unit 11 and the second S/D unit 13, the first S/D unit 11 is connected to odd groups of the multiple groups of data lines 30, the second S/D unit 13 is connected to even groups of the multiple groups of data lines 30, and each of the odd groups and the even groups includes at least one data line 30.

In this embodiment, the data lines 30 of the display panel 100 are divided into multiple groups which are alternately arranged. Each group includes at least one data line 30. For example, each group may include 1, 2 or 3 data lines. The multiple groups of data lines 30 which are alternately arranged are divided into the odd groups and the even groups according to a sequence of the groups. To further improve the display effect of the display panel 100, each of the odd groups and the even groups includes a same number of data lines 30, so that the data lines 30 in any region of the display panel 100 can maximally obtain the input voltages of the S/D units 10 on the two sides for complete mixing, and the probability of forming non-uniform cutting at the middle position is effectively reduced. The S/D units 10 distributed on the two sides of the display panel 100 include the first S/D unit 11 and the second S/D unit 13, the first S/D unit 11 is connected to the odd groups of the multiple groups of data lines 30 and the second S/D unit 13 is connected to the even groups of the multiple groups of data lines 30. In another embodiment, the first S/D unit 11 may alternatively be connected to the even groups of the multiple groups of data lines 30 and the second S/D unit 13 is connected to the odd groups of the multiple groups of data lines 30.

Optionally, referring to FIG. 1, each of the odd groups and the even groups includes one data line 30, the first S/D unit 11 is connected to the first, third, . . . , (2n−3)^{th} and (2n−1)^{th} data lines 30 of the display panel 100, and the second S/D unit 13 is connected to the second, fourth, . . . , (2n−2)^{th} and 2n^{th} data lines 30 of the display panel 100.

In this embodiment, each of the odd groups and the even groups includes one data line 30. That is, each data line 30 of the display panel 100 independently forms a group. The first S/D unit 11 is connected to the odd groups of data lines 30 of the display panel 100, that is, the first S/D unit 11 is connected to the first, third, . . . , (2n−3)^{th} and (2n−1)^{th} data lines 30 of the display panel 100. For example, for an 8K display panel, the display panel 100 includes 7,680 odd and even alternate groups of data lines 30, each odd group includes one data line 30, and the first S/D unit 11 is connected to the first, third, fifth, . . . , 7,675^{th}, 7677^{th} and 7,679^{th} data lines 30 of the 8K display panel. For example, for a 10K display panel, the display panel 100 includes 10,240 odd and even alternate groups of data lines 30, each odd group includes one data line 30 and the first S/D unit 11 is connected to the first, third, fifth, . . . , 10,235^{th}, 10,237^{th} and 10,239^{th} data lines 30 of the 10K display panel. The second S/D unit 13 is connected to the even groups of data lines of the display panel 100, that is, the second S/D unit 13 is connected to the second, fourth, . . . , (2n−2)^{th} and 2n^{th} data lines 30 of the display panel 100. For example, for the 8K display panel, the display panel 100 includes the 7,680 odd and even alternate groups of data lines 30, each even group includes one data line 30, and the second S/D unit 13 is connected to the second, fourth, sixth, . . . , 7,676^{th}, 7678^{th} and 7,680^{th} data lines 30 of the 8K display panel. For example, for the 10K display panel, the display panel 100 includes the 10,240 odd and even alternate groups of data lines 30, each even group includes a data line 30, and the second S/D unit 13 is connected to the second, fourth, sixth, . . . , 10,236^{th}, 10,238^{th} and 10,240^{th} data lines 30 of the 10K display panel.

Optionally, referring to FIG. 2, each of the odd groups and the even groups includes two data lines 30, the first S/D unit 11 is connected to the first, second, fifth, sixth, . . . , (2n−7)^{th}, (2n−6)^{th}, (2n−3)^{th} and (2n−2)^{th} data lines 30 of the display panel 100 and the second S/D unit 13 is connected to the third, fourth, seventh, eighth, . . . , (2n−5)^{th}, (2n−4)^{th}, (2n−1)^{th} and 2n^{th} data lines 30 of the display panel 100.

In this embodiment, each of the odd groups and the even groups includes two data lines 30. That is, every two data lines 30 of the display panel 100 independently form a group and then the groups are divided into the odd groups and the even groups according to a sequence of each group. The first S/D unit 11 is connected to the odd groups of data lines 30 of the display panel 100, that is, the first S/D unit 11 is connected to the first, second, fifth, sixth, . . . , (2n−7)^{th}, (2n−6)^{th}, (2n−3)^{th} and (2n−2)^{th} data lines 30 of the display panel 100. For example, for the 8K display panel, the display panel 100 includes 3,840 odd and even alternate groups of data lines 30, each odd group includes two data lines 30, and the first S/D unit 11 is connected to the first, second, fifth, sixth, . . . , 7673^{th}, 7674^{th}, 7,677^{th} and 7,678^{th} data lines 30 of the 8K display panel. For example, for the 10K display panel, the display panel 100 includes 5,120 odd and even alternate groups of data lines 30, each odd group includes one data line 30 and the first S/D unit 11 is connected to the first, second, fifth, sixth, . . . , 10,233^{th}, 10,234^{th}, 10,237^{th} and 10,238^{th} data lines 30 of the 10K display panel. The second S/D unit 13 is connected to the even groups of data lines 30 of the display panel 100, that is, the second S/D unit 13 is connected to the third, fourth, seventh, eighth . . . , (2n−5)^{th}, (2n−4)^{th}, (2n−1)^{th} and 2n^{th} data lines 30 of the display panel 100. For example, for the 8K display panel, the display panel 100 includes the 3,840 odd and even alternate groups of data lines 30, each even group includes two data lines 30, and the second S/D unit 13 is connected to the third, fourth, seventh, eighth, . . . , 7,765^{th}, 7,676^{th}, 7,679^{th} and 7680^{th} data lines 30 of the 8K display panel. For example, for the 10K display panel, the display panel 100 includes the 5,120 odd and even alternate groups of data lines 30, each group includes two data lines 30, and the second S/D unit 13 is connected to the third, fourth, seventh, eighth, . . . , 10,235^{th}, 10,236^{th}, 10,239^{th} and 10,240^{th} data lines 30 of the 10K display panel.

Optionally, the data lines connected to the first S/D unit 11 are defined as first data lines, the data lines connected to the second S/D unit 13 are defined as second data lines, and the first data lines and the second data lines are alternately arranged or may be alternately arranged at an interval of multiple groups. In addition, the first S/D unit 11 may be arranged at an upper half part or a right half part of the display panel 100 and the second S/D unit 13 may be arranged at a lower half part or a left half part of the display panel 100. Alternatively, the first S/D unit 11 may be arranged at the lower half part or left half part of the display panel 100 and the second S/D unit 13 may be arranged at the upper half part or the right half part of the display panel 100. The longitudinally alternate first S/D unit 11 and second S/D unit 13 may be arranged to perform charging at any position of the display panel 100. Maximal mixing is ensured and the phenomenon of non-uniform display similar to a relatively serious cutting line is unlikely to occur.

Optionally, the step of controlling the S/D units to charge the respectively connected data lines of the display panel specifically includes the following step:

controlling, according to the data signal, the first S/D unit to charge the data lines in the odd groups and simultaneously controlling the second S/D unit to charge the data lines in the even groups.

In this embodiment, the data lines 30 of the display panel 100 are divided into multiple groups which are alternately arranged. Each group includes at least one data line 30. For example, each group may include 1, 2 or 3 data lines. The multiple groups of data lines which are alternately arranged are divided into the odd groups and the even groups according to a sequence of the groups. To further improve the display effect of the display panel 100, each of the odd groups and the even groups includes a same number of data lines 30, so that the data lines 30 in any region of the display panel 100 can maximally obtain the input voltages of the S/D units 10 on the two sides for complete mixing, and the probability of forming non-uniform cutting at the middle position is effectively reduced. The S/D units 10 distributed on the two sides of the display panel 100 include the first S/D unit 11 and the second S/D unit 13, the first S/D unit 11 is connected to the odd groups of the multiple groups of data lines 30 and the second S/D unit 13 is connected to the even groups of the multiple groups of data lines 30. In another embodiment, the first S/D unit 11 may alternatively be connected to the even groups of the multiple groups of data lines 30 and the second S/D unit 13 is connected to the odd groups of the multiple groups of data lines 30. When an image signal is driven to be displayed, a master control program of the display panel 100, controls, according to the data signal, the first S/D unit 11 to charge the data lines 30 of the odd groups and simultaneously controls the second S/D unit to charge the data lines in the even groups, the first S/D unit 11 and the second S/D unit 13 cooperate to charge the liquid crystals in the display panel 100, an arrangement direction of the liquid crystals changes again when the gate drive signal is input, and an image is displayed on the display panel 100.

Optionally, referring to FIGS. 1 and 2, the display panel 100 further includes a G/D unit 50, arranged on a side, having a shorter length, of the display panel 100. The G/D unit 50 outputs a voltage through scan lines (not shown in the figures) of the display panel 100 to control a thin film transistor (not shown in the figures) of the display panel 100 to be switched on and off.

In this embodiment, the display panel 100 includes the G/D unit 50. The G/D unit 50 receives the sequential control signal input by the TCON or the control board and sequentially outputs the voltage to the scan lines, connected thereto, of the display panel 100. The G/D unit 50 outputs the voltage to a gate of the thin film transistor of the display panel 100 through the scan lines of the display panel 100 to control the thin film transistor to be switched on and off and further cooperates with the data signal input into the data lines by the S/D units 10 to drive the image input signal to be displayed on the display panel.

Furthermore, referring to FIGS. 1 and 2, the present disclosure further discloses a display panel drive device. A display panel 100 includes S/D units 10 distributed on two opposite sides of the display panel 100. The S/D units 10 are longitudinally or transversely alternately connected to data lines 30 of the display panel 100. The drive device includes:

a signal output unit, controlling an input signal of a system end to be output as a data signal and a control signal;

a charging unit, controlling the S/D units to charge the respectively connected data lines of the display panel; and

a display unit, controlling a gate drive signal to be input to display the input signal.

According to the drive device of the present disclosure, the two S/D units 10 are controlled according to an architecture composition of the display panel 100 and the output data signal to simultaneously input charging voltages to the respectively connected data lines 30 of the display panel 100 to charge liquid crystals in the display panel 100, and then the gate drive signal is controlled to be input according to the output control signal to display the input signal. The condition that a cutting line is formed due to non-uniform display at the middle position of the display panel under influence of non-uniform impedance of the display panel when the S/D units charge the middle position of the display panel through the data lines is avoided, and a display effect of the display panel 100 is improved.

Optionally, the display panel 100 includes multiple groups of data lines 30, the S/D units 10 include the first S/D unit 11 and the second S/D unit 13, the first S/D unit 11 is connected to odd groups of the multiple groups of data lines 30, the second S/D unit 13 is connected to even groups of the multiple groups of data lines 30, each of the odd groups and the even groups includes at least one data line 30, and the charging unit is further configured to:

control, according to the data signal, the first S/D unit to charge the data lines in the odd groups and simultaneously control the second S/D unit to charge the data lines in the even groups.

Optionally, referring to FIG. 1, each of the odd groups and the even groups includes one data line 30, the first S/D unit 11 is connected to the first, third, . . . , (2n−3)^{th} and (2n−1)^{th} data lines 30 of the display panel 100 and the second S/D unit 13 is connected to the second, fourth, . . . , (2n−2)^{th} and 2n^{th} data lines 30 of the display panel 100. The step of controlling the S/D units according to the data signal to charge the respectively connected data lines of the display panel specifically includes the following step:

controlling, according to the data signal, the first S/D unit to charge the data lines in the odd groups and simultaneously controlling the second S/D unit to charge the data lines in the even groups.

Optionally, referring to FIG. 2, each of the odd groups and the even groups includes two data lines 30, the first S/D unit 11 is connected to the first, second, fifth, sixth, . . . , (2n−7)^{th}, (2n−6)^{th}, (2n−3)^{th} and (2n−2)^{th} data lines 30 of the display panel 100 and the second S/D unit 13 is connected to the third, fourth, seventh, eighth, . . . , (2n−5)^{th}, (2n−4)^{th}, (2n−1)^{th} and 2n^{th} data lines 30 of the display panel 100. The step of controlling the S/D units according to the data signal to charge the respectively connected data lines of the display panel specifically includes the following step:

controlling, according to the data signal, the first S/D unit to charge the data lines in the odd groups and simultaneously controlling the second S/D unit to charge the data lines in the even groups.

The present disclosure further discloses a display device, which includes the above display panel drive device.

In this embodiment, the display device may be a television or a computer, or may be a monitoring display terminal. The display device includes the above display panel 100. The display panel 100 includes a first S/D unit 11 and second S/D unit 13 distributed on two opposite sides of the display panel 100. The first S/D unit 11 is connected to odd groups of data lines 30 of the display panel 100. The second S/D unit 13 is connected to even groups of data lines 30 of the display panel 100. Each of the odd groups and the even groups includes at least one data line 30. When an image signal is displayed, the first S/D unit 11 is controlled to charge the data lines in the odd groups, the second S/D unit 13 is controlled to charge the data lines in the even groups, and then a gate drive signal is controlled to be input to display the image signal. The condition that a cutting line is formed due to non-uniform display at a middle position of the display panel under influence of non-uniform impedance of the display panel when the S/D units charge the middle position of the display panel through the data lines is avoided, and a display effect of the display panel 100 is improved.

The present disclosure further discloses a display panel drive method, which is applied to a display device such as a television or a computer. A display panel includes a first S/D unit and a second S/D unit distributed on two opposite sides of the display panel and the first S/D unit and the second S/D unit are longitudinally or transversely alternately connected to odd groups and even groups of multiple groups of data lines of the display panel. The display drive method includes the following steps: controlling an input signal of a system end to be output as a data signal and a control signal; controlling, according to the data signal, the first S/D unit to charge the data lines in the odd groups and simultaneously controlling the second S/D unit to charge the data lines in the even groups; and controlling a gate drive signal to be input according to the control signal to display the input signal.

Detailed descriptions about the above display panel drive method are similar to the above embodiments and thus will not be elaborated herein.

The display panel drive method and drive device disclosed in the present disclosure may be applied to an ultra-high definition display panel. The ultra-high definition display panel may be driven by a logic board of a full high definition display panel. The display panel may be an LCD panel, an OLED display panel, a QLED display panel, a curved display panel or another display panel.

The foregoing descriptions are merely examples of the embodiments of the present disclosure but are not intended to limit the patent scope of the present disclosure. Any equivalent modification made to the structures or procedures based on the content of the specification and the accompanying drawings of the present disclosure for direct or indirect use in other relevant technical fields shall fall into the patent protection scope of the present disclosure.

1. A display panel drive method, wherein a display panel comprising source driver units distributed on two opposite sides of the display panel and the display panel drive method comprising:
substantially alternately connecting one or more groups of data lines of the display panel to the source driver units;
controlling an input signal of a system end to be output as a data signal and a control signal;
controlling the source driver units to charge the respectively connected data lines of the display panel; and
controlling a gate drive signal to be input to display the input signal.

2. The display panel drive method according to claim 1, wherein the display panel comprises multiple groups of data lines, the source driver units comprise a first source driver unit and a second source driver unit, the first source driver unit is connected to odd groups or even groups of the multiple groups of data lines, the second source driver unit is connected to the even groups or odd groups of the multiple groups of data lines, and each of the odd groups and the even groups comprises at least one data line.

3. The display panel drive method according to claim 2, wherein each of the odd groups and the even groups comprises a same number of data lines.

4. The display panel drive method according to claim 1, wherein the source driver units comprise a first source driver unit and a second source driver unit and are respectively arranged on the two sides, having a longer length, of the display panel.

5. The display panel drive method according to claim 4, wherein the data lines connected to the first source driver unit are defined as first data lines, the data lines connected to the second source driver unit are defined as second data lines, and the first data lines and the second data lines are alternately arranged.

6. The display panel drive method according to claim 5, wherein the first data lines and the second data lines are alternately arranged at an interval of multiple groups.

7. The display panel drive method according to claim 2, wherein the step of controlling the source driver units to charge the respectively connected data lines of the display panel specifically comprises:
controlling, according to the data signal, the first source driver unit to charge the data lines in the odd groups or the even groups and simultaneously controlling the second source driver unit to charge the data lines in the even groups or the odd groups.

8. A display panel drive device, comprising:
multiple groups of source driver units, distributed on two opposite sides of a display panel, one or more groups of data lines of the display panel being substantially alternately connected to the multiple groups of source driver units;
a signal output unit, controlling an input signal of a system end to be output as a data signal and a control signal;
a charging unit, electrically connected to the multiple groups of source driver units to control the multiple groups of source driver units according to the data signal to charge the substantially alternately connected data lines of the display panel; and
a display unit, displaying the input signal when a gate drive signal is input.

9. The drive device according to claim 8, wherein the display panel comprises multiple groups of data lines, the source driver units comprise a first source driver unit and a second source driver unit, the first source driver unit is connected to odd groups or even groups of the multiple groups of data lines, the second source driver unit is connected to the even groups or odd groups of the multiple groups of data lines, each of the odd groups and the even groups comprises at least one data line, and the charging unit is further configured to:
control, according to the data signal, the first source driver unit to charge the data lines in the odd groups or the even groups and simultaneously control the second source driver unit to charge the data lines in the even groups or the odd groups.

10. The drive device according to claim 9, wherein each of the odd groups and the even groups comprises a same number of data lines.

11. The drive device according to claim 8, wherein the source driver units comprise a first source driver unit and a second source driver unit and are respectively arranged on the two sides, having a longer length, of the display panel.

12. The drive device according to claim 11, wherein the data lines connected to the first source driver unit are defined as first data lines, the data lines connected to the second source driver unit are defined as second data lines, and the first data lines and the second data lines are alternately arranged.

13. The drive device according to claim 12, wherein the first data lines and the second data lines are alternately arranged at an interval of multiple groups.

14. A display panel drive method, a display panel comprising a first source driver unit and a second source driver unit distributed on two opposite sides of the display panel and the display panel drive method comprising:
longitudinally or transversely alternately connecting one or more groups of data lines of the display panel to odd groups and even groups of multiple groups of data lines of the source driver units;
controlling an input signal of a system end to be output as a data signal and a control signal;
controlling, according to the data signal, the first source driver unit to charge the data lines in the odd groups or the even groups and simultaneously controlling the second source driver unit to charge the data lines in the even groups or the odd groups; and
controlling a gate drive signal to be input according to the control signal to display the input signal.

15. The display panel drive method according to claim 14, wherein each of the odd groups and the even groups comprises at least one data line.

16. The display panel drive method according to claim 15, wherein each of the odd groups and the even groups comprises a same number of data lines.

17. The display panel drive method according to claim 14, wherein the source driver units comprise a first source driver unit and a second source driver unit and are respectively arranged on the two sides, having a longer length, of the display panel.

18. The display panel drive method according to claim 17, wherein the first source driver unit is positioned at an upper half part or a lower half part of the display panel when being longitudinally alternately connected to the data lines and is positioned at a left half part or a right half part of the display panel when being transversely alternately connected to the data lines, the second source driver unit is positioned at the lower half part or the upper half part of the display panel when being longitudinally alternately connected to the data lines and is positioned at the left half part or the right half part of the display panel when being transversely alternately connected to the data lines, and the longitudinally alternate or transversely alternate first source driver unit and second source driver unit perform charging at any position of the display panel.

19. The display panel drive method according to claim 18, wherein the display panel further comprises a gate driver unit distributed on a side, having a shorter length, of the display panel, and the gate driver unit sequentially outputs a voltage to scan lines, connected thereto, of the display panel.
